(19) United States
(12) Patent Application Publication
(10) Pub. No.: US 2025/0104249 A1
(43) Pub. Date: Mar. 27, 2025

(54) METHOD AND APPARATUS FOR PERFORMING ENHANCED CENTER-BASED PANOPTIC SEGMENTATION

(71) Applicant: Electronics and Telecommunications Research Institute, Daejeon (KR)

(72) Inventors: Hee Kyung LEE, Daejeon (KR); Hyon Gon CHOO, Daejeon (KR); Yeong Jun KOH, Daejeon (KR); Jong Hyeon BAEK, Daejeon (KR)

(73) Assignee: Electronics and Telecommunications Research Institute, Daejeon (KR)

(21) Appl. No.: 18/899,304

(22) Filed: Sep. 27, 2024

(30) Foreign Application Priority Data
Sep. 27, 2023 (KR) 10-2023-0131152

(51) Int. Cl. G06T 7/12; G06V 10/44; G06V 10/74; G06V 10/764; G06V 10/771

(52) U.S. Cl. CPC G06T 7/12; G06V 10/44; G06V 10/761; G06V 10/764; G06V 10/771

(57) ABSTRACT

The present disclosure relates to a method and apparatus for performing enhanced center-based panoptic segmentation. A method according to an embodiment of the present disclosure may comprise: extracting a plurality of image feature maps based on an input image; extracting first image feature data through a transformer-based encoder; extracting second image feature data through a pixel decoder; selecting a query set through a query selection unit; extracting an updated query set through a transformer-based decoder; and generating a predicted class and a predicted segmented image. In this regard, A selection operation may be performed on predicted classes and predicted segment images for at least one query on the object.

### CROSS-REFERENCE TO RELATED APPLICATIONS

This application claims the benefit of earlier filing date and right of priority to Korean Application No. 10-2023-0131152, filed on Sep. 27, 2023, the contents of which are all hereby incorporated by reference herein in their entirety.

### TECHNICAL FIELD

The present disclosure relates to a method and apparatus for performing high-performance panoptic image segmentation for extracting objects of interest.

### BACKGROUND

Image segmentation is a method to separate what each segment means at the pixel level of the image.

Image segmentation methods may be broadly classified into three types: semantic segmentation, which assigns meaning to all pixels of an image; instance segmentation, which identifies the location of each object and assigns meaning to pixels corresponding to the object; and panoptic segmentation, which performs both of the above-described segmentation methods.

In order to extract objects of interest from an image, an instance segmentation method and/or a panoptic segmentation method may be applied. The panoptic segmentation method may simultaneously segment objects (things) and backgrounds (e.g., stuff), so it may be flexibly used in more diverse applications.

In the case of a general panoptic segmentation method, a single image is input, and semantic segmentation and instance segmentation are performed through a feature extraction network and an encoder/decoder module (e.g., Encoder/Decoder), and the panoptic segmentation results may be derived through postprocessing of the results of semantic segmentation and instance segmentation, i.e., the two prediction results.

### SUMMARY

The technical object of the present disclosure is to provide a method and apparatus for performing enhanced center-based panoptic segmentation for extracting an object of interest.

Specifically, the technical object of the present disclosure is to provide a method and apparatus for selecting a query by utilizing the center information of an object and independently learning/training a query set in a transformer decoder.

The technical objects to be achieved by the present disclosure are not limited to the above-described technical objects, and other technical objects which are not described herein will be clearly understood by those skilled in the pertinent art from the following description.

A method for panoptic image segmentation according to an aspect of the present disclosure may comprise: extracting a plurality of image feature maps based on an input image; extracting first image feature data using image feature maps remaining from among the plurality of image feature maps excluding a specific image feature map, through a transformer based encoder; extracting second image feature data using the specific image feature map and the first image feature data, through a pixel decoder; selecting a query set including at least one query for an object using a center information map based on the first image feature data, through a query selection unit; extracting an updated query set using the first image feature data and the query set, through a transformer based decoder; and based on the updated query set, generating a predicted class through learned class information and segmented image information, and generating a predicted segmented image using the second image feature data and the segmented image information. In this regard, a selection operation on a predicted class and a predicted segmented image may be performed for at least one query for the object, based on a pre-configured threshold value.

An apparatus of performing panoptic image segmentation according to another aspect of the present disclosure may comprise at least one processor and at least one memory, and the processor may be configured to: extract first image feature data using image feature maps remaining from among the plurality of image feature maps excluding a specific image feature map, through a transformer based encoder; extract second image feature data using the specific image feature map and the first image feature data, through a pixel decoder; select a query set including at least one query for an object using a center information map based on the first image feature data, through a query selection unit; extract an updated query set using the first image feature data and the query set, through a transformer based decoder; and based on the updated query set, generate a predicted class through learned class information and segmented image information, and generate a predicted segmented image using the second image feature data and the segmented image information. In this regard, a selection operation on a predicted class and a predicted segmented image may be performed for at least one query for the object, based on a pre-configured threshold value.

As one or more non-transitory computer readable medium storing one or more instructions according to the other aspect of the present disclosure, the one or more instructions may be executed by one or more processors and control an apparatus for performing panoptic image segmentation to: extract first image feature data using image feature maps remaining from among the plurality of image feature maps excluding a specific image feature map, through a transformer based encoder; extract second image feature data using the specific image feature map and the first image feature data, through a pixel decoder; select a query set including at least one query for an object using a center information map based on the first image feature data, through a query selection unit; extract an updated query set using the first image feature data and the query set, through a transformer based decoder; and based on the updated query set, generate a predicted class through learned class information and segmented image information, and generate a predicted segmented image using the second image feature data and the segmented image information. In this regard, a selection operation on a predicted class and a predicted segmented image may be performed for at least one query for the object, based on a pre-configured threshold value.

In various aspects of the present disclosure, the query set may include K queries selected based on class probability information for a center information-based feature map obtained by applying an object center relation map to a learnable information center map based on the center information map.

Additionally, in various aspects of the present disclosure, the learnable information center map may be obtained by inputting the center information map into a linear and normalization layer.

Additionally, in various aspects of the present disclosure, the object center relation map may be obtained by inputting the learnable information center map into a feed forward network layer.

Additionally, in various aspects of the present disclosure, the center information-based feature map may be obtained through an addition operation with a result of a channel-wise multiplication operation between the learnable information center map and the object center relation map and the learnable information center map.

Additionally, in various aspects of the present disclosure, the K queries may be based on K having high class probability values among class probabilities predicted for each pixel of the center information-based feature map.

Additionally, in various aspects of the present disclosure, the updated query set may be extracted by a self-attention operation that receives the query set and a pre-configured decoupling mask as inputs and a deformable attention operation that receives the first image feature data and an output of the self-attention operation as inputs.

Additionally, in various aspects of the present disclosure, an object of interest is extracted based on the predicted class and predicted segmented image selected through the selection operation, and the extraction of the object of interest is performed by assigning a class semantic value according to an increase in an object unique variable to the selected predicted class and predicted segmented image.

Additionally, in various aspects of the present disclosure, calculating similarity between the predicted class and predicted segmented image selected and correct class and correct segmented image, through the selection operation and calculating a loss function for selecting a learnable query that satisfies a pre-configured level of the similarity among the query set may be further comprised.

The features briefly summarized above regarding the present disclosure are merely exemplary aspects of the detailed description of the present disclosure that follows and do not limit the scope of the present disclosure.

According to the present disclosure, a method and apparatus for selecting a query by utilizing the center information of an object and independently learning a query set in a transformer decoder may be provided.

According to the present disclosure, unlike the existing transformer-based panoptic image segmentation network, the query selection is performed based on more accurate information, and the query set is efficiently learned using a decoupling mask during the computation process, so there is a technical effect of more accurately extracting the object of interest mask.

Effects achievable by the present disclosure are not limited to the above-described effects, and other effects which are not described herein may be clearly understood by those skilled in the pertinent art from the following description.

### BRIEF DESCRIPTION OF THE DRAWINGS

FIG. 1 illustrates an operational flowchart of a method for performing panoptic image segmentation according to an embodiment of the present disclosure.

FIG. 2 illustrates a neural network structure related to derivation of a panoptic segmented image according to an embodiment of the present disclosure.

FIG. 3 illustrates a transformer encoder structure according to an embodiment of the present disclosure.

FIG. 4 illustrates a pixel decoder structure according to an embodiment of the present disclosure.

FIG. 5 illustrates the structure of a center-guided query selection network according to an embodiment of the present disclosure.

FIG. 6 illustrates the structure of a transformer decoder unit, an MLP unit, and a class and mask generation unit according to an embodiment of the present disclosure.

FIG. 7 is a block diagram illustrating a device according to an embodiment of the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of and/or includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

As described above, image segmentation methods may be divided into i) semantic segmentation that assigns meaning to all pixels of an image, ii) instance segmentation that identifies the location of each object and assigns meaning to pixels corresponding to the object, and iii) panoptic segmentation that performs both of the aforementioned segmentations.

In this regard, the panoptic segmentation network/structure before DETR (End-to-End Object Detection with Transformers) was considered consists of an encoder/decoder module for semantic segmentation mask prediction and an encoder/decoder module for instance segmentation mask prediction, and thus the number of queries and computational amount of the overall network is large.

Additionally, for the DETR-based panoptic segmentation network, an end-to-end learning method is applied, and a two-stage network based on a transformer is configured in a convolution-based model.

That is, the DETR-based panoptic segmentation process is performed by passing through an object detection network, then passing through a transformer network based on the bounding box information of the predicted objects, and then passing through a Feature Pyramid Network (FPN)-style convolutional layer to perform prediction. However, this transformer-based two-stage network has the disadvantage of a long learning time and excessively increasing inference time in that object detection shall be performed before panoptic image segmentation is performed.

Considering these points, the present disclosure proposes a new network/structure based on a transformer that only performs panoptic image segmentation, which not only improves panoptic image segmentation learning time but also enhances performance.

The method proposed in the present disclosure is to improve the performance of a panoptic image segmentation network for extracting objects of interest. Specifically, the method proposed in the present disclosure relates to a method for improving a transformer decoder module in a panoptic image segmentation network and a query selection module for improving performance.

The convolution-based panoptic image segmentation network may be performed by extracting an image feature map through an encoder composed of convolutions (e.g., an encoder composed of convolution layers) from an input image, and restoring an image feature map whose size is the same as that of the correct image through a decoder. Thereafter, semantic image segmentation is performed through a semantic image segmentation prediction layer (e.g., Sematic Head) (i.e., a semantic segmentation image generation), and object image segmentation can be performed through an instance image segmentation prediction layer (e.g., Instance Head) (i.e., an object segmentation image generation). Thereafter, post-processing may be performed on the results of the above two segmentations to derive a panoptic image (i.e., a panoptic segmentation image).

In relation to image segmentation, before the aforementioned DETR (End-to-End Object Detection with Transformers) was considered, the convolution-based panoptic image segmentation network described above was considered as the main network. However, in the case of the method, in order to derive panoptic image segmentation, semantic image segmentation and instance image segmentation prediction shall be performed, and due to this structure, there is a disadvantage that the complexity and computational amount of the network are large. In addition, in terms of inference, since a postprocessing process is performed for each of semantic image segmentation and instance image segmentation, and then a post-processing process for panoptic image segmentation is required, there is a disadvantage that the inference time is long.

Additionally, with respect to the image segmentation method proposed in the present disclosure, a panoptic image segmentation network method (e.g., DETR-based method) that may significantly improve performance while simply changing the structure compared to previous methods may be considered.

In the case of the method, by adding a transformer-based encoder together with a convolution-based encoder, a well-expressed image feature map may be derived compared to the existing method. In addition, by using a learnable query called a query set, an attention operation between the query set and the image feature map derived from the encoder is performed, and instead of restoring the image feature map like a convolution-based encoder, the image feature map is injected into the query, so that each class and segmented image may be derived.

The method proposed in the present disclosure is based on a transformer-based network method with greatly improved performance, and is a module that extracts more accurate feature information and utilizes it as a query set without utilizing learnable queries, and a method for efficiently proceeding with learning of the selected query set in the transformer decoder module. This is a new method that proposes a method of selecting queries by utilizing the center information of objects in a query selection method that utilizes learnable queries in the existing transformer-based network method, and independently learning the query set in the transformer decoder. Through this, the method proposed in the present disclosure aims to improve the performance of panoptic image segmentation.

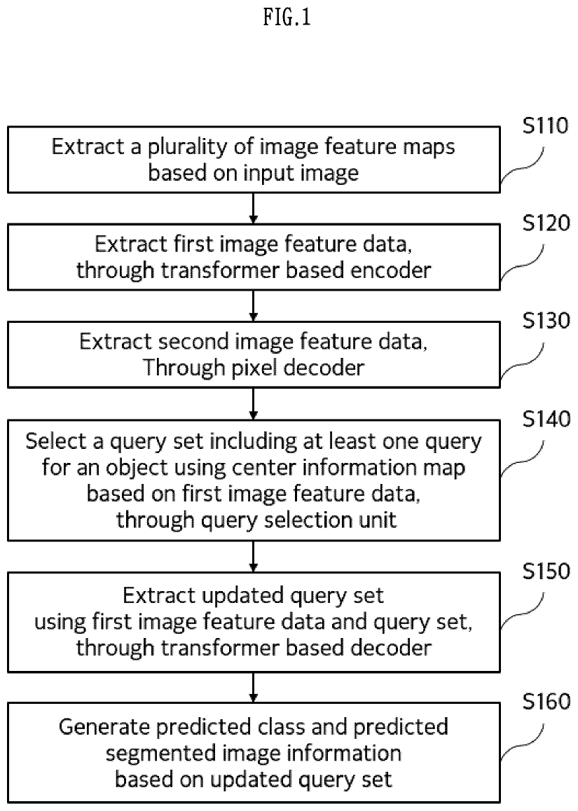

FIG. 1 illustrates an operational flowchart of a method for performing panoptic image segmentation according to an embodiment of the present disclosure.

In step S110, a plurality of image feature maps (e.g., F_{res2 . . . res5}) may be extracted based on an input image (e.g., RGB image).

In step S120, first image feature data (e.g., F_{encoder}) may be extracted using the remaining image feature maps (e.g., F_{res3 . . . res5}) excluding a specific image feature map (e.g., Fᵣₑₛ₂) from among the plurality of image feature maps through a transformer-based encoder.

For example, the specific image feature map may correspond to a large image feature map having the smallest input size of the transformer-based encoder among the plurality of image feature maps.

In step S130, second image feature data (e.g., Fₘₐₛₖ) may be extracted using the specific image feature map and the first image feature data through a pixel decoder.

In step S140, a query set (e.g., [symbol] ) including at least one query for the object may be selected using a center information map (e.g., F_{center}) based on the first image feature data through a query selection unit.

For example, the query set may include K queries selected based on class probability information for a center information-based feature map obtained by applying an object-centered relation map (e.g., a center heatmap H) to a learnable center information map (e.g., F′_{center}) based on the center information map.

In this regard, the learnable information center map may be obtained by inputting the center information map into a linear and normalization layer.

Additionally or alternatively, the object-centered relevance map may be obtained by inputting the learnable information-centered map into a feed forward network layer.

Additionally or alternatively, the center information-based feature map may be obtained by performing a channel-wise multiplication operation between the learnable information center map and the object center related map and an addition operation with the learnable information center map.

Additionally or alternatively, the K queries may be based on K indices having high class probability values among the class probabilities predicted for each pixel of the center information-based feature map.

In step S150, an updated query set (e.g., [symbol] _{update}) may be extracted using the first image feature data and the query set through a transformer based decoder.

In this regard, the updated query set may be extracted by a self-attention operation that receives the query set and a pre-configured decoupling mask (e.g., decoupling mask D) as inputs and a deformable attention operation that receives the first image feature data and the output of the self-attention operation as inputs.

In step S160, based on the updated query set, a predicted class (e.g., y′class) may be generated through learned class information and segmented image information, and a predicted segmented image (e.g., y′mask) may be generated using the second image feature data and the segmented image information.

In this regard, a selection operation for a predicted class and a predicted segmentation image may be performed for at least one query for an object based on a pre-configured threshold.

Additionally, an object of interest may be extracted based on the predicted class and predicted segmentation image selected through the selection operation. Here, the extraction of the object of interest may be performed by assigning a class semantic value according to an increase in the object-specific variable to the selected predicted class and predicted segmentation image.

Additionally, although not shown in FIG. 1, the similarity between the predicted class and predicted segmented image selected through the above selection operation and the correct class and correct segmented image may be calculated. In addition, a loss function for selecting a learnable query that satisfies a preset level of similarity among the above query set may be calculated.

Referring to the contents of the above-described FIG. 1, the present disclosure explains a specific method for improving the learning time and performance of panoptic image segmentation by utilizing the center information of an object in the panoptic segmentation method.

The proposed method in the present disclosure to achieve the above-described purpose corresponds to a transformer-based panoptip segmentation method based on supervised learning.

For the panoptic image segmentation described in the present disclosure, it is assumed that a general RGB (red, green, blue) image is used/considered as an input image, and a mask image in which each pixel is given a meaning is used/considered as a correct image.

In this regard, in the method of configuring a correct image in the present disclosure, a label indicating an object is referred to as “things,” and a label indicating something other than an object (e.g., background) is referred to as “stuffs.”

Existing panoptic segmentation image networks (e.g., DETR-based methods) assign learnable queries in a transformer decoder as a query set, and inject image feature maps into the query set to derive classes and segmented images without distinguishing between “things” and “stuffs.”

In contrast, the proposed method in the present disclosure may divide the query set into “things” and “stuffs” to retain the unique characteristics of the labels before injecting the image features into the query set. In addition, the center information of the object may be utilized to select a more accurate query set. Based on this, a query set selection module and a masking technique may be utilized to efficiently learn the divided query set to extract classes and segmented images. By adding such modules and learning techniques, the panoptic image segmentation performance may be improved.

Additionally, it goes without saying that the proposed method in the present disclosure may be extended and applied even when other types of input images and/or correct images are used/considered.

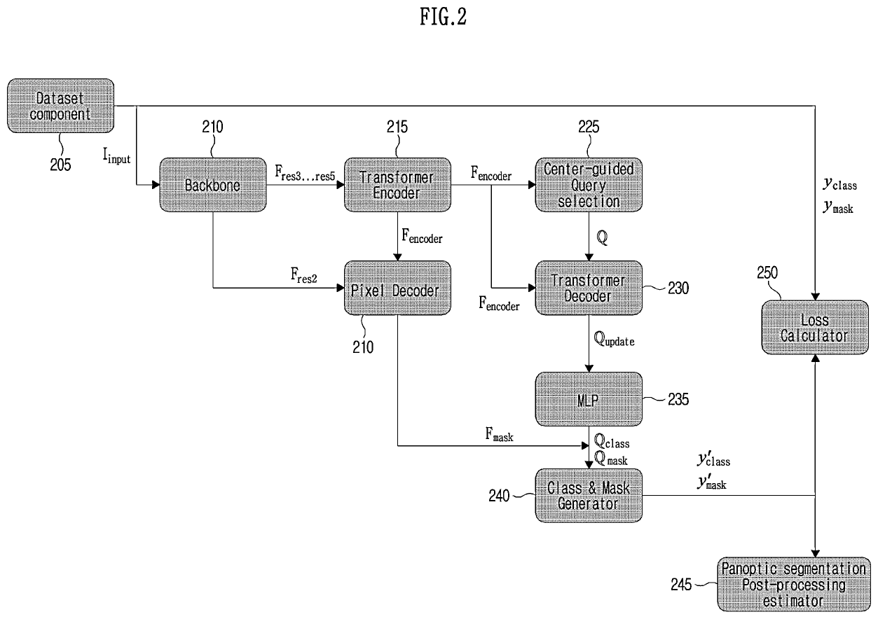

FIG. 2 illustrates a neural network structure related to derivation of a panoptic segmented image according to an embodiment of the present disclosure.

Referring to FIG. 2, a deep learning-based panoptic segmentation image generation neural network structure may be considered, and FIG. 2 exemplifies a method of using a single image, generating a segmentation image using y′mask, and deriving a panoptic segmentation image by predicting a class through y′class.

Each component illustrated in FIG. 2 may be configured in the form of a unit/module.

For example, the neural network/network structure for the proposed method in the present disclosure may include a dataset component unit (205), a backbone unit (210), a transformer encoder unit (215), a pixel decoder unit (220), a center-guided query selection unit (225), a transformer decoder unit (230), a multi-layer perceptron unit (MLP) (235), a class and mask generation unit (240), a panoptic segmentation post-processing estimation unit (245), and a loss function calculator unit (250).

Below, each component shown in FIG. 2 is described in detail.

The dataset component unit (205) may include/perform a dataset generation process for training a deep learning network.

For example, the a dataset generation process may include setting up an original image of RGB channels and a correct mask image in which each pixel has a meaning, and conducting training and inference by distinguishing between the “things” class and the “stuffs” class.

The backbone unit (210) may mean a network composed of a convolutional neural network that receives an input image (e.g., an RGB image) and derives an image feature map to be input to a transformer encoder unit (215), a pixel decoder unit (220), a center-guided query selection unit (225), and/or a transformer decoder unit (230).

For example, as illustrated in FIG. 2, an input image Iᵢₙₚᵤₜ of an RGB channel may be input to the backbone unit (210). In this case, after passing through the network, image feature maps F_{res2 . . . res5} of various sizes may be extracted. At this time, among the extracted image feature maps, multi-scale image feature maps (F_{res3 . . . res5}) excluding the image feature map (Fᵣₑₛ₂) with the largest (input) size may be used as input to the transformer encoder unit (215).

The transformer encoder unit (215) may mean a network composed of a transformer (based) neural network that receives a multi-scale image feature map as input, reduces the multi-scale image feature map to the input channel dimension of the transformer encoder by passing it through one convolutional layer, and receives it as input.

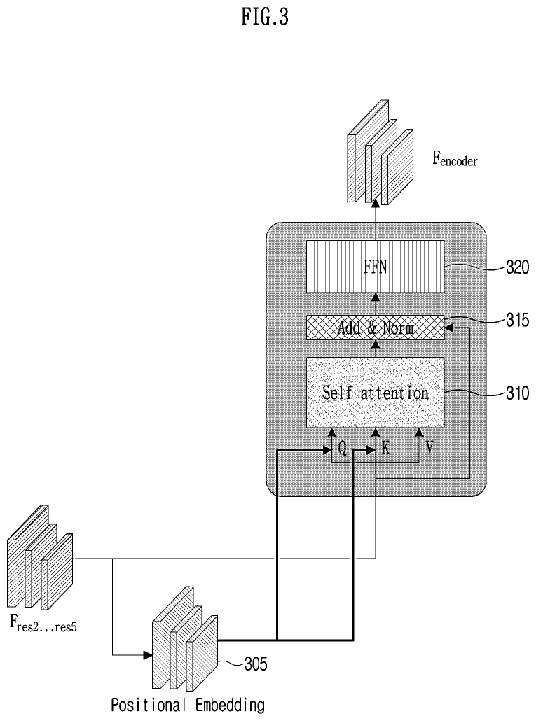

FIG. 3 illustrates a transformer encoder structure according to an embodiment of the present disclosure.

Referring to FIG. 3, the transformer encoder structure/network may include layers such as positional encoding (305), self-attention (310), add and normalization (315), and feed forward network (FFN) (320).

The transformer encoder structure/network may extract a high-dimensional feature vector using the image feature map that has passed through the backbone unit (210) (i.e., the backbone network). The image feature map that has passed through the transformer encoder structure/network may be used as an input to the pixel decoder unit (220), the center-guided query selection unit (225), and/or the transformer decoder unit (230).

Specifically, positional encoding (305) may be a layer for generating absolute position information values of image feature map(s) in a neural network of a transformer encoder structure.

Self-attention (310) may be a structure that applies an operation to obtain/find similarity between image feature maps in a neural network of a transformer encoder structure.

Add and normalization (315) may be a structure designed to pass through a normalization layer after adding the image feature map derived from self-attention (310) and the image feature map before derivation.

Feed forward network (FFN) (320) may correspond to a multilayer perceptron network consisting of an input layer, a hidden layer, and an output layer through which the image feature map derived from add and normalization (315) passes.

The specific functions and actions of the transformer encoder unit (215) may be as follows.

For example, the transformer encoder unit (215) may receive a multi-scale image feature map F_{res3 . . . res5}, a size of the multi-scale image feature map

$$[ \frac{H}{8} \times \frac{W}{8} \times C , \frac{H}{16} \times \frac{W}{16} \times C , \frac{H}{32} \times \frac{W}{32} \times C ] ,$$

and an absolute position information value PE_{encoder} of the image feature map for each scale derived through the positional encoding layer.

The self-attention layer may receive a total of three inputs [Q, K, V], and F_{res3 . . . res5}+PE_{encoder} may be input as Q and K, and F_{res3 . . . res5} may be input as V. Based on the inputs, the value Attn_{encoder}, which calculates the similarity between image feature maps, may be output/obtained.

Add and normalization may receive self-attention-performed values Attn_{encoder} and image feature maps F_{res3 . . . res5} as input, and normalization may be performed after adding the inputs.

After normalization, image feature maps may be extracted/derived via a feed-forward network (FFN).

The above process may be repeated a total of a number of times (e.g., 6 times) to derive an improved multi-scale image feature map F_{encoder}. F_{encoder} may be input to a pixel decoder unit (220), a center-guided query selection unit (225), and a transformer decoder unit (230).

In this regard, F_{encoder} may be [F¹_{encoder}, F²_{encoder}, F³_{encoder}]. Also, each size of F_{encoder} may be

$$[ \frac{H}{8} \times \frac{W}{8} \times C , \frac{H}{16} \times \frac{W}{16} \times C , \frac{H}{32} \times \frac{W}{32} \times C ] .$$

The pixel decoder unit (220) may receive as input image feature maps of various scales (i.e., image feature maps of various sizes) extracted from the backbone unit (210) and image feature maps derived from the transformer encoder unit (215) for generating predicted image segmentation.

Based on the input, the pixel decoder unit (220) may extract prediction segmentation information while increasing the image feature size by a certain multiple (e.g., 2 times).

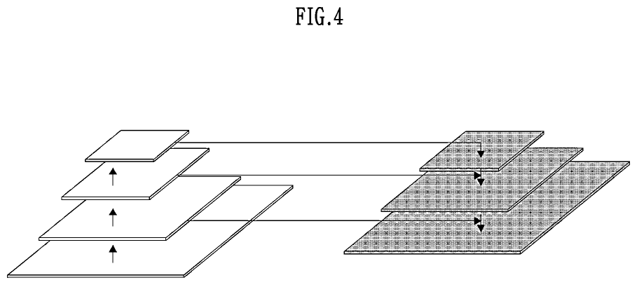

FIG. 4 illustrates a pixel decoder structure according to an embodiment of the present disclosure.

Referring to FIG. 4, the pixel decoder may extract/generate prediction segmentation information by increasing the image feature size for the input image feature map by a certain multiple.

For example, the pixel decoder unit (220) may receive the image feature map Fᵣₑₛ₂ and the output value F_{encoder} of the transformer encoder unit (215). Based on the input F_{encoder}, the pixel decoder unit (220) may increase F³_{encoder} by the size of F²_{encoder}, add it to F²_{encoder}, pass it through the convolution layer to derive F₂, and increase F₂ by the size of F¹_{encoder}, add it to F¹_{encoder}, pass it through the convolution layer to derive F₁. Finally, the image feature map Fₘₐₛₖ may be obtained by adding the value of F₁ that is doubled to Fᵣₑₛ₂.

The center-guided query selection unit (225) may refer to a network that selects a query by receiving an image feature map F_{encoder} derived from a transformer encoder unit (215) as input to generate a “things” query based on the center information of an object.

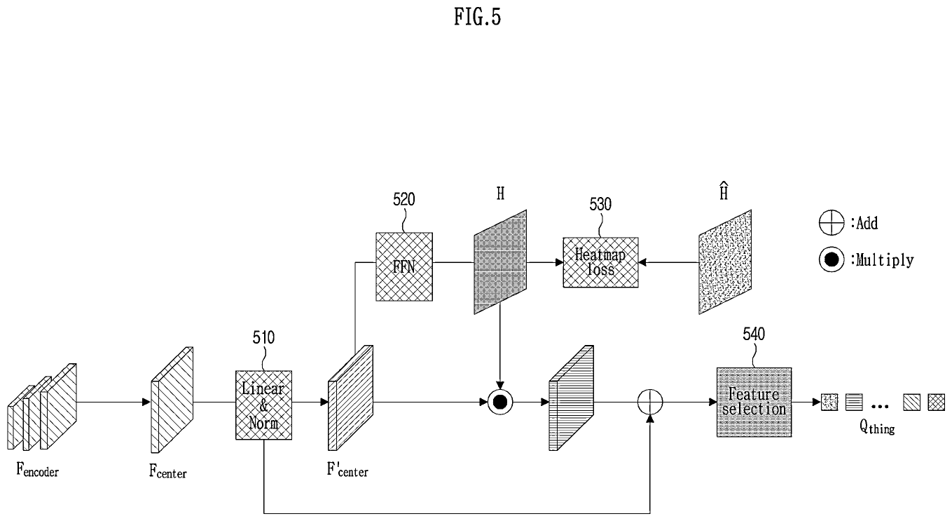

FIG. 5 illustrates the structure of a center-guided query selection network according to an embodiment of the present disclosure.

Referring to FIG. 5, the center-guided query selection network may be constructed based on Linear & Norm (510), Feed Forward Network (FFN) (520), Heatmap Loss (530), and Feature Selection (540).

For example, linearization and normalization (510) is a process of applying weights to an image feature map and may be composed of a fully connected layer (e.g., Linear in FIG. 5) and a normalization layer (e.g., Nrom in FIG. 5).

For example, the feed forward network (520) may be constructed with a multilayer perceptron network with an output dimension of 1 to derive a center heatmap from a learnable center feature map F′_{center}.

For example, the heatmap loss (530) may mean an objective function between the center heatmap (H) derived from the feedforward network (520) and the correct center heatmap (Ĥ).

For example, feature selection (540) may be configured as an algorithm that estimates class probability from a feature map reflecting a central heatmap, extracts an index of a feature map with the highest class probability value through a Top-k operation, etc., and derives the feature map of the corresponding index as a “things” query.

Below, the specific operation of the centrally guided query election network is described.

First, the center information map F_{center} may be obtained/output through the same structure as the pixel decoder unit (220) of FIG. 4.

Next, F_{center} may be passed through a linearization and normalization (510) layer to change it into a learning state.

For example, by designing a fully connected layer (e.g., Linear in FIG. 5) and a normalization layer (e.g., Nrom in FIG. 5), weights are assigned to F_{center}, and a learnable center feature map F′_{center} may be obtained/output based on this.

Next, to learn the center information of the object, the dimension is reduced to 1 through FFN to derive the center heatmap H (i.e., the object center heatmap H), and then the heatmap loss (530) may be measured based on the derived center heatmap H and the correct center heatmap Ĥ.

Additionally, the center information may be reflected in the learnable center information map F′_{center} through channel-wise multiplication and addition operations on the corresponding center heatmap H.

In addition, after estimating the class probability from the feature map that reflects the learnable central heatmap H, the index of the feature map with the highest probability value may be extracted and the feature map of that index can be selected as the “things” query. At this time, the “stuffs” query may be specified as a learnable parameter.

For example, to select a “things” query, the class probability may be predicted for each pixel of the feature map reflecting the center information. Among these, K pixels with high class probability values may be selected, and “things” queries N_{thing}×C may be derived based on the indices corresponding to the K. In addition, for the “stuffs” query, a query set [symbol] may be constructed by setting the learnable query N_{stuff}×C.

The transformer decoder unit (230) may mean a transformer decoder network that receives an image feature map F_{encoder} derived from the transformer encoder unit (215) and a query set Q derived by the center-guided query selection unit (225).

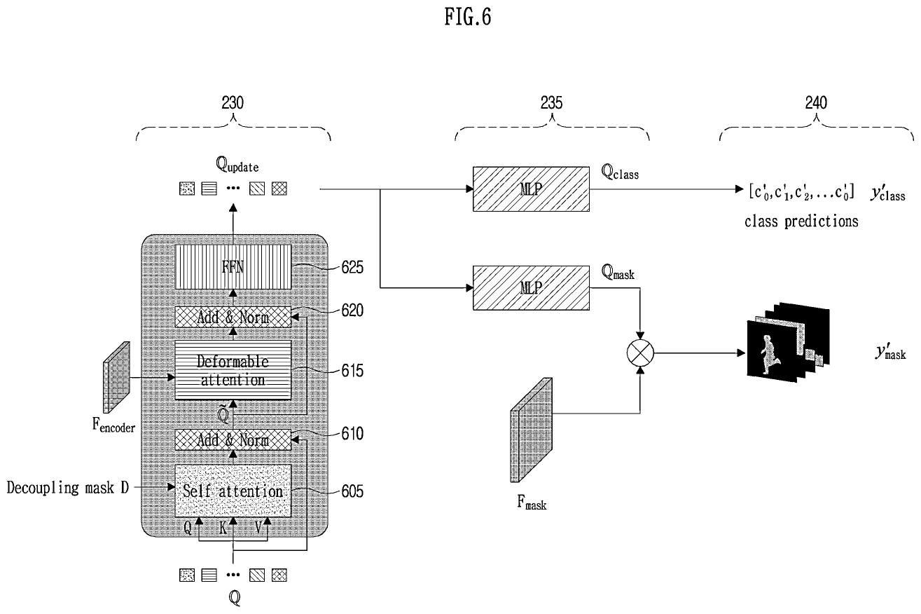

FIG. 6 illustrates the structure of a transformer decoder unit, an MLP unit, and a class and mask generation unit according to an embodiment of the present disclosure.

Referring to FIG. 6, the transformer decoder unit (230) may be composed of layers such as self-attention (605), add & normalization (610, 620), deformable-attention (615), and feed forward network (FNN) (625).

Specifically, deformable-attention (615) may be a structure that applies an operation to find similarity between a query and surrounding pixels of an image feature map in a neural network of a transformer decoder structure.

In addition, self-attention (605) may be configured in a multi-head self-attention manner and may be a structure that applies an operation for finding/obtaining similarity between image feature maps in a neural network of a transformer encoder structure.

In addition, the add and normalization (610) may be a structure designed to pass through a normalization layer after adding the image feature map derived from self-attention (605) and the image feature map before derivation. Additionally, the add and normalization (620) may be a structure designed to pass through a normalization layer after adding the image feature map derived from deformable-attention (615) and the image feature map before derivation.

In this regard, the decoupling mask D input to the self-attention (605) may be defined/declared as in the following Equation 1.

$$D ( i , j ) = \{ \begin{matrix}0 & if i , j ≦ {N}_{thing} , \\ 0 & if {N}_{thing} < i , j ≦ {N}_{thing} + {N}_{stuff} , \\ - ∞ & otherwise .\end{matrix} \qquad [ Equation 1 ]$$

For example, a transformer decoder network may first declare a decoupling mask D based on the formula in Equation 1 and input it to self-attention to independently learn the unique features of the “things” query set and the “stuffs” query set.

Deformable attention (615) may receive the output [symbol] of self-attention (605) as Q, and the image feature map F_{encoder} as K and V, and perform an operation to calculate the similarity between them.

Feed forward network (FNN) (625) may update the query set.

By repeating this process multiple times (for example, 9 times in total), [symbol] _{update} may be derived.

The MLP unit (235) may receive [symbol] _{update} derived from the transformer decoder unit (230) and pass it through a multilayer perceptron to learn the class [symbol] _{class} and segmented image information [symbol] ₘₐₛₖ.

The class and mask generation unit (240) generates/predicts the class y′_{class} through the class [symbol] _{class}, which is the output of the MLP unit, and the segmented image information [symbol] ₘₐₛₖ, and may generate/predict the segmented image y′ₘₐₛₖ through the matrix multiplication between the output values Fₘₐₛₖ and [symbol] ₘₐₛₖ of the pixel decoder unit (220).

The panoptic segmentation post-processing estimation unit (245) may receive predicted classes and masks for each learned individual query, and perform a selection task based on a pre-configured threshold.

With respect to the selected class, “things” and “stuffs” are distinguished, and if the predicted class is “things” (e.g., objects), the class semantic value may be assigned to the image segmentation while increasing the object-specific variable for that class. On the other hand, if the predicted class is “stuffs” (e.g., things other than objects), the class semantic value may be assigned to the image segmentation as in the semantic segmentation method.

The loss function calculator unit (250) first calculates the similarity between the correct class and the correct image segment based on each predicted class and image segment, and calculates a loss function that selects only parameters similar to the correct answer rather than using all queries through 1:1 matching.

The loss function calculator unit (250) may receive as input a query selected through the loss function, and calculate a loss function between the correct class y_{class} and the predicted class y′_{class}.

In this regard, a sigmoid function-based focal loss function may be used as a class loss function.

As image segmentation loss functions, two loss functions may be used: a binary segmentation loss function between the predicted image segmentation y′ₘₐₛₖ and the correct image yₘₐₛₖ, and a loss function that calculates the overlapping area (e.g., intersection over union) between the predicted image segmentation y′ₘₐₛₖ and the correct image yₘₐₛₖ.

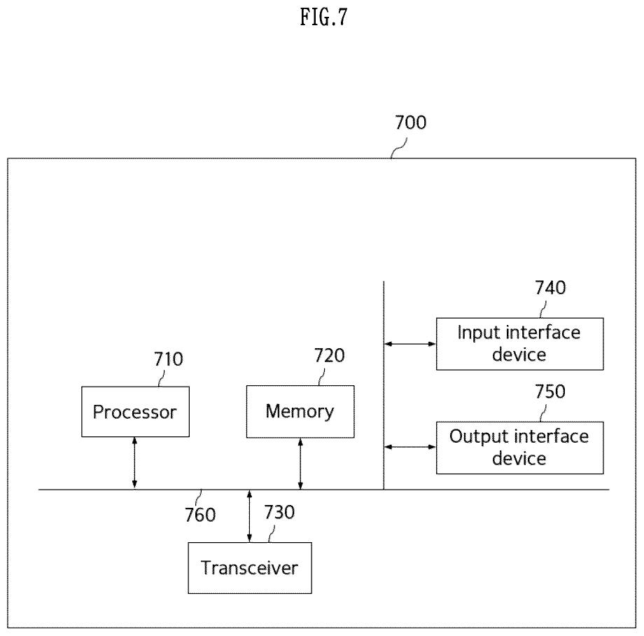

FIG. 7 is a block diagram illustrating an apparatus according to an embodiment of the present disclosure.

Referring to FIG. 7, the device (700) may represent a device in which the panoptic image segmentation method described in the present disclosure is implemented.

For example, the device (700) may comprehensively support/perform functions of the dataset component unit (205), the backbone unit (210), the transformer encoder unit (215), the pixel decoder unit (220), the center-guided query selection unit (225), the transformer decoder unit (230), the multi-layer perceptron unit (MLP) unit (235), the class and mask generation unit (240), the panoptic segmentation post-processing estimation unit (245), the loss function calculator unit (250), etc., as described in the above-described FIG. 2.

The device 700 may include at least one of a processor 710, a memory 720, a transceiver 730, an input interface device 740, and an output interface device 750. Each of the components may be connected by a common bus 760 to communicate with each other. In addition, each of the components may be connected through a separate interface or a separate bus centering on the processor 710 instead of the common bus 760.

The processor 710 may be implemented in various types such as an application processor (AP), a central processing unit (CPU), a graphic processing unit (GPU), etc., and may be any semiconductor device that executes a command stored in the memory 720. The processor 710 may execute a program command stored in the memory 720. The processor (710) may be configured to implement the panoptic image segmentation method/device described based on FIGS. 1 to 6 described above.

And/or, the processor 710 may store a program command for implementing at least one function for the corresponding modules in the memory 720 and may control the operation described based on FIGS. 1 to 6 to be performed.

The memory 720 may include various types of volatile or non-volatile storage media. For example, the memory 720 may include read-only memory (ROM) and random access memory (RAM). In an embodiment of the present disclosure, the memory 720 may be located inside or outside the processor 710, and the memory 720 may be connected to the processor 710 through various known means.

The transceiver 730 may perform a function of transmitting and receiving data processed/to be processed by the processor 710 with an external device and/or an external system.

The input interface device 740 is configured to provide data to the processor 710.

The output interface device 750 is configured to output data from the processor 710.

According to the proposed method and device in the present disclosure, the query set is divided into a “things” query and a “stuffs” query and input to the transformer decoder for more accurate query set selection. The “things” query has the technical effect of facilitating learning through a query selection method based on the central information of the object. Afterwards, there is the technical effect of being able to learn without affecting each other through a decoupling mask operation to maintain the unique information of the separated query sets.

In addition, according to the proposed method and device in the present disclosure, unlike the existing transformer-based panoptic image segmentation network, the query selection step is performed based on more accurate information, and the query set may be efficiently learned using the decoupling mask during the computation process. Through this, there is a technical effect of more accurately extracting the object of interest mask.

The components described in the example embodiments may be implemented by hardware components including, for example, at least one digital signal processor (DSP), a processor, a controller, an application-specific integrated circuit (ASIC), a programmable logic element, such as an FPGA, GPU other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers.

A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors. Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment.

Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, it is intended that this disclosure embrace all other substitutions, modifications and variations belong within the scope of the following claims.

What is claimed is:

1. A method for panoptic image segmentation, the method comprising:
extracting a plurality of image feature maps based on an input image;
extracting first image feature data using image feature maps remaining from among the plurality of image feature maps excluding a specific image feature map, through a transformer based encoder;
extracting second image feature data using the specific image feature map and the first image feature data, through a pixel decoder;
selecting a query set including at least one query for an object using a center information map based on the first image feature data, through a query selection unit;
extracting an updated query set using the first image feature data and the query set, through a transformer based decoder; and
based on the updated query set, generating a predicted class through learned class information and segmented image information, and generating a predicted segmented image using the second image feature data and the segmented image information, and
wherein a selection operation on a predicted class and a predicted segmented image is performed for at least one query for the object, based on a pre-configured threshold value.

2. The method of claim 1,
wherein the query set includes K queries selected based on class probability information for a center information-based feature map obtained by applying an object center relation map to a learnable information center map based on the center information map.

3. The method of claim 2,
wherein the learnable information center map is obtained by inputting the center information map into a linear and normalization layer.

4. The method of claim 2,
wherein the object center relation map is obtained by inputting the learnable information center map into a feed forward network layer.

5. The method of claim 2,
wherein the center information-based feature map is obtained through an addition operation with a result of a channel-wise multiplication operation between the learnable information center map and the object center relation map and the learnable information center map.

6. The method of claim 2,
wherein the K queries are based on K indices having high class probability values among class probabilities predicted for each pixel of the center information-based feature map.

7. The method of claim 1,
wherein the updated query set is extracted by a self-attention operation that receives the query set and a pre-configured decoupling mask as inputs and a deformable attention operation that receives the first image feature data and an output of the self-attention operation as inputs.

8. The method of claim 1,
wherein an object of interest is extracted based on the predicted class and predicted segmented image selected through the selection operation, and
wherein the extraction of the object of interest is performed by assigning a class semantic value according to an increase in an object unique variable to the selected predicted class and predicted segmented image.

9. The method of claim 1, further comprising:
calculating similarity between the predicted class and predicted segmented image selected and correct class and correct segmented image, through the selection operation; and
calculating a loss function for selecting a learnable query that satisfies a pre-configured level of the similarity among the query set.

10. An apparatus of performing panoptic image segmentation, the apparatus comprising:
at least one processor and at least one memory,
wherein the processor is configured to:
extract first image feature data using image feature maps remaining from among the plurality of image feature maps excluding a specific image feature map, through a transformer based encoder;
extract second image feature data using the specific image feature map and the first image feature data, through a pixel decoder;
select a query set including at least one query for an object using a center information map based on the first image feature data, through a query selection unit;
extract an updated query set using the first image feature data and the query set, through a transformer based decoder; and
based on the updated query set, generate a predicted class through learned class information and segmented image information, and generate a predicted segmented image using the second image feature data and the segmented image information, and
wherein a selection operation on a predicted class and a predicted segmented image is performed for at least one query for the object, based on a pre-configured threshold value.

11. The apparatus of claim 10,
wherein the query set includes K queries selected based on class probability information for a center information-based feature map obtained by applying an object center relation map to a learnable information center map based on the center information map.

12. The apparatus of claim 11,
wherein the learnable information center map is obtained by inputting the center information map into a linear and normalization layer.

13. The apparatus of claim 11,
wherein the object center relation map is obtained by inputting the learnable information center map into a feed forward network layer.

14. The apparatus of claim 11,
wherein the center information-based feature map is obtained through an addition operation with a result of a channel-wise multiplication operation between the learnable information center map and the object center relation map and the learnable information center map.

15. The apparatus of claim 11,
wherein the K queries are based on K having high class probability values among class probabilities predicted for each pixel of the center information-based feature map.

16. The apparatus of claim 10,
wherein the updated query set is extracted by a self-attention operation that receives the query set and a pre-configured decoupling mask as inputs and a deformable attention operation that receives the first image feature data and an output of the self-attention operation as inputs.

17. The apparatus of claim 10,
wherein an object of interest is extracted based on the predicted class and predicted segmented image selected through the selection operation, and
wherein the extraction of the object of interest is performed by assigning a class semantic value according to an increase in an object unique variable to the selected predicted class and predicted segmented image.

18. The apparatus of claim 10,
wherein the processor is configured to:
calculate similarity between the predicted class and predicted segmented image selected and correct class and correct segmented image, through the selection operation; and
calculate a loss function for selecting a learnable query that satisfies a pre-configured level of the similarity among the query set.

19. One or more non-transitory computer readable medium storing one or more instructions,
wherein the one or more instructions are executed by one or more processors and control an apparatus for performing panoptic image segmentation to:
extract first image feature data using image feature maps remaining from among the plurality of image feature maps excluding a specific image feature map, through a transformer based encoder;
extract second image feature data using the specific image feature map and the first image feature data, through a pixel decoder;
select a query set including at least one query for an object using a center information map based on the first image feature data, through a query selection unit;
extract an updated query set using the first image feature data and the query set, through a transformer based decoder; and
based on the updated query set, generate a predicted class through learned class information and segmented image information, and generate a predicted segmented image using the second image feature data and the segmented image information, and
wherein a selection operation on a predicted class and a predicted segmented image is performed for at least one query for the object, based on a pre-configured threshold value.

20. The computer readable medium of claim 19,
wherein the query set includes K queries selected based on class probability information for a center information-based feature map obtained by applying an object center relation map to a learnable information center map based on the center information map.
